(19) United States
(12) Patent Application Publication
(10) Pub. No.: US 2024/0399515 A1
(43) Pub. Date: Dec. 5, 2024

(54) PERIMETER AND INFILL OPTIMIZATIONS FOR LIQUID METAL JETTING 3D PRINTING

(71) Applicant: Additive Technologies, LLC d/b/a ADDiTEC, Palm City, FL (US)

(72) Inventors: Chu-Heng LIU, Penfield, NY (US); PriyaankaDevi GUGGILAPU, Durham, NC (US); Paul J. McCONVILLE, Webster, NY (US)

(73) Assignee: Additive Technologies, LLC d/b/a ADDiTEC, Palm City, FL (US)

(21) Appl. No.: 18/329,259

(22) Filed: Jun. 5, 2023

(51) Int. Cl. B23K 37/06; B23K 26/342

(52) U.S. Cl. CPC B23K 37/06; B23K 26/342; B33Y 10/00; B33Y 30/00; B33Y 50/02

(57) ABSTRACT

A method for printing a 3D part with a 3D printer includes ejecting drops of a build material from a nozzle of the 3D printer. A first plurality of the drops forms a perimeter of the 3D part, and a second plurality of the drops forms an infill of the 3D part. The method also includes controlling a parameter such that the parameter has a first value while the first plurality of the drops is ejected. The method also includes controlling the parameter such that the parameter has a second value while the second plurality of the drops is ejected, wherein the first and second values are different.

### TECHNICAL FIELD

The present teachings relate generally to three-dimensional (3D) printing and, more particularly, to systems and methods for optimizing the printing of a perimeter and/or an infill of a 3D part with a 3D liquid metal jet printer.

### BACKGROUND

Three-dimensional (3D) printing jets a liquid build material through an ejector. A plurality of drops of the liquid build material are ejected from a nozzle of the ejector. The drops fall onto a build plate where they cool and solidify to form a 3D part. Each layer of the 3D part includes a perimeter and an infill. The perimeter traces the outline of the 3D part, thereby creating a strong and accurate exterior. The infill is printed inside of the perimeter and makes up the remainder of the layer.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A method for printing a 3D part with a 3D printer is disclosed. The method includes ejecting drops of a build material from a nozzle of the 3D printer. A first plurality of the drops forms a perimeter of the 3D part, and a second plurality of the drops forms an infill of the 3D part. The method also includes controlling a parameter such that the parameter has a first value while the first plurality of the drops is ejected. The method also includes controlling the parameter such that the parameter has a second value while the second plurality of the drops is ejected, wherein the first and second values are different.

In another embodiment, the method includes ejecting drops of a build material from a nozzle of the 3D printer. A first plurality of the drops forms a perimeter of the 3D part, and a second plurality of the drops forms an infill of the 3D part. The build material includes a metal. The method also includes controlling a parameter such that the parameter has a first value while the first plurality of the drops is ejected. The first value causes the first plurality of the drops to cool to below a predetermined temperature threshold faster than a predetermined time threshold such that a drop spreading induced spot size in the perimeter is less than a predetermined threshold. The method also includes controlling the parameter such that the parameter has a second value while the second plurality of the drops is ejected. The second value causes the second plurality of the drops to cool to below the predetermined temperature threshold slower than the predetermined time threshold such that a drop spreading induced spot size in the infill is greater than the predetermined threshold. The parameter includes a frequency at which the drops are ejected, a density of the drops, a volume of the drops, a mass of the drops, a downward speed of the drops, a temperature of the drops when the drops are ejected, a spot temperature of landing spots of the drops prior to the drops landing, or a combination thereof.

A 3D printer is also disclosed. The 3D printer includes an ejector having a nozzle that is configured to eject drops of a build material. The drops land and solidify to form at least a portion of a 3D part. A first plurality of the drops forms a perimeter of the 3D part. A second plurality of the drops forms an infill of the 3D part. The 3D printer also includes a controller configured to control a parameter such that the parameter has a first value while the first plurality of the drops is ejected. The controller is also configured to control the parameter such that the parameter has a second value while the second plurality of the drops is ejected. The first and second values are different.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 depicts a schematic cross-sectional side view of a 3D printer, according to an embodiment.

FIG. 2A depicts a schematic view of a layer of a 3D part including a perimeter and an infill that are formed from drops having the same size, according to an embodiment.

FIG. 2B depicts a schematic view of the layer of the 3D part including the perimeter and the infill that are formed from drops having different sizes, according to an embodiment.

FIG. 3 depicts images of three different phases of solidified drops on the 3D part, according to an embodiment.

FIG. 4 depicts a flowchart of a method for printing the 3D part with the 3D printer, according to an embodiment.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

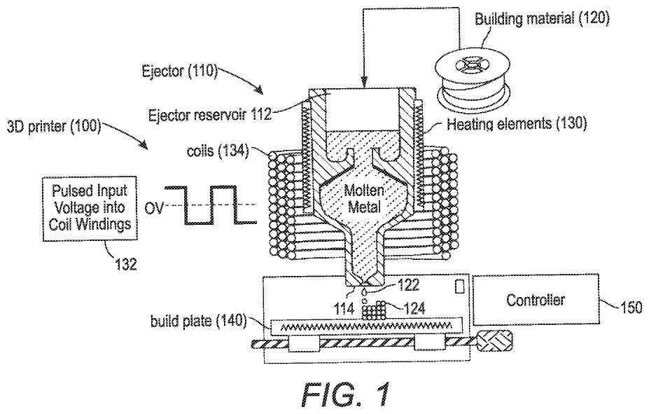

FIG. 1 depicts a schematic cross-sectional side view of a 3D printer 100, according to an embodiment. The 3D printer 100 may be or include a magnetohydrodynamic (MHD) printer, a piezoelectric-driven printer, or the like. The 3D printer 100 may include an ejector (also referred to as a pump) 110. As used herein, the ejector 110 refers to a structure that can be selectively activated to cause a build material 120 to be ejected from a nozzle 114 of the ejector 110. As used herein, the nozzle 114 refers to a physical structure from which the build material 120 begins flight.

The ejector 110 may define one or more reservoirs 112. One ejector reservoir 112 is shown in FIG. 1. In another embodiment, the ejector 110 may include two or more reservoirs including at least a first (e.g., upper) reservoir and a second (e.g., lower) reservoir. In this embodiment, the portion of the ejector 110 defining the upper reservoir may be or include a ceramic material, and the portion of the ejector 110 defining the lower reservoir may be or include a graphite material.

The ejector reservoir(s) 112 is/are configured to receive and/or store the build material 120 that is to be ejected from the nozzle 114. The build material 120 may be or include a metal (e.g., pure or an alloy), a polymer, a ceramic, ink, or the like. In one embodiment, the build material 120 may be greater than about 50% metal, greater than 60% metal, greater than 70% metal, greater than 80% metal, greater than 90% metal, or about 100% metal (e.g., by volume and/or mass). For example, the build material 120 may be or include a spool of aluminum wire (e.g., 6061 aluminum). In another embodiment, the build material 120 may be or include copper or other metals.

The 3D printer 100 may also include one or more heating elements 130. The heating elements 130 are configured to melt the build material 120 within the ejector reservoir 112, thereby converting the build material 120 from a solid state to a liquid (e.g., molten) state within the ejector reservoir 112.

The 3D printer 100 may also include a power source 132 and one or more metallic coils 134. The metallic coils 134 are wrapped at least partially around the ejector 110 and/or the heating elements 130. The power source 132 may be coupled to the coils 134 and configured to provide power thereto. In one embodiment, the power source 132 may be configured to provide a step function direct current (DC) voltage profile (e.g., voltage pulses or jetting pulses) to the coils 134, which may create an increasing magnetic field. The increasing magnetic field may cause an electromagnetic and/or electromotive force within the ejector 110, that in turn causes an induced electrical current in the liquid build material 120. The magnetic field and the induced electrical current in the liquid build material 120 may create a radially inward force on the liquid build material 120, known as a Lorentz force. The Lorentz force creates a pressure at an inlet of the nozzle 114 of the ejector 110. The pressure causes the liquid build material 120 to be jetted through and/or ejected from the nozzle 114 in the form of one or more drops 122.

The 3D printer 100 may also include a build plate (also referred to as a substrate) 140 that is positioned below the nozzle 114. The drops 122 may be ejected from the nozzle 114 and subsequently land on the build plate 140 where they may cool and solidify to form a first (e.g., bottom) layer. Additional drops 122 may be jetted to form layer upon layer that eventually produces a 3D part 124.

The 3D printer 100 may also include controller 150. The controller 150 may control the balance between spreading (also referred to as flow) and solidification of the drops 122 that form 3D part 124. The spreading may affect the bonding of the drops 122 to the 3D part 124, and the solidification may affect the fidelity of the 3D part 124. On one hand, the controller 150 may control one or more parameters that cause the drops 122 to flow and/or spread sufficiently to conform to the surface of the 3D part 124 and bond to the underlying structure. On the other hand, the controller 150 may control the one or more parameters that cause the drops 122 to solidify quickly enough to maintain their precise locations and achieve the desired geometrical accuracy for the 3D part 124. This process balance affects the process control, part quality, and productivity.

The parameters may include the volume of the drops 122, the mass of the drops 122, the speed (i.e., velocity) of the drops 122, the frequency of the drops 122 (i.e., the frequency at which the drops 122 are ejected from the nozzle 114), the temperature of the drops 122 (e.g., at the time that the drops 122 are ejected from the nozzle 114), the temperature of the build environment around the drops 122 and/or 3D part 124, the temperature of the 3D part 124 (e.g., the most recently-printed layer thereof), the spacing between two adjacent drops 122, or a combination thereof.

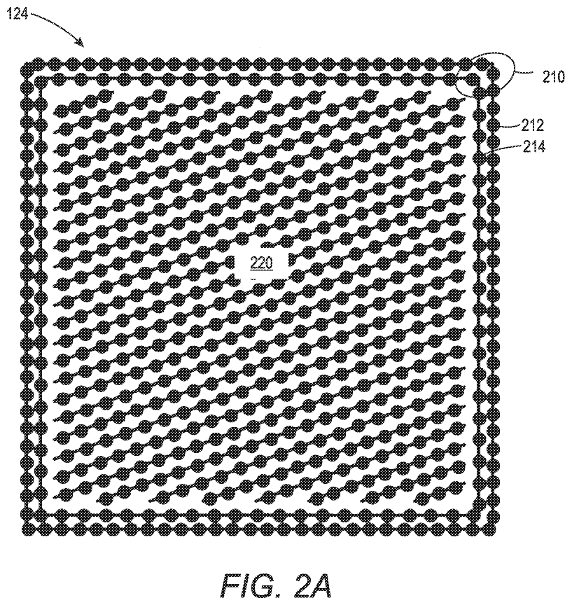

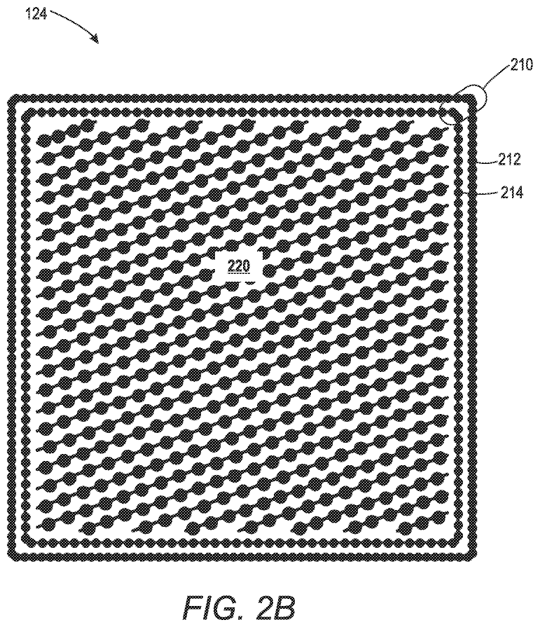

FIG. 2A depicts a schematic view of a layer of a 3D part 124 including a perimeter 210 and an infill 220 that are formed from drops 122 having the same size, according to an embodiment. FIG. 2B depicts a schematic view of the layer of the 3D part 124 including the perimeter 210 and the infill 220 that are formed from drops 122 having different sizes, according to an embodiment. The 3D printer 100 may use a perimeter/infill toolpath approach to print the 3D part 124. More particularly, one or more smooth toolpath(s) may be drawn to form the perimeter 210 of a cross-section (e.g., layer) of the 3D part 124. The continuous nature of the perimeter 210 may produce a smooth surface of the 3D part 124. In one example, two toolpaths may be used, forming an outer perimeter 212 and an inner perimeter 214. The controller 150 may cause the value(s) of the parameter(s) to be different when printing the outer perimeter 212, the inner perimeter 214, the infill 220, or a combination thereof. In an example, the value(s) of the parameter(s) may be optimized when printing the outer perimeter 212, while the inner perimeter 214 may use values between those used when printing the outer perimeter 212 and the infill 220.

A set of parallel lines (or raster lines) may be used to fill the space enclosed by the perimeter 210. This is called the infill 220. In one embodiment, the same hardware and process parameters may be used for both perimeter and infill printing.

The controller 150 may improve the geometrical quality and/or mechanical properties of the 3D part 124 (e.g., simultaneously) through the separate modifications (e.g., optimizations) of the printing of the perimeter 210 and/or the infill 220. More particularly, the controller 150 may control the one or more parameters while the perimeter 210 of the 3D part 124 is being printed such that the (e.g., liquid metal) drops 122 may solidify more quickly with less spreading and/or flow. The controller 150 may also control the one or more parameters while the infill 220 is being printed such that the (e.g., liquid metal) drops 122 may solidify less quickly with more spreading and/or flow. The controller 150 may accomplish this by causing the parameters to have different values during the printing of the perimeter 210 and the infill 220. For example, as shown in FIG. 2B, the drops 122 that make up the perimeter 210 may have a smaller size (e.g., volume and/or mass) than the drops 122 that make up the infill 220.

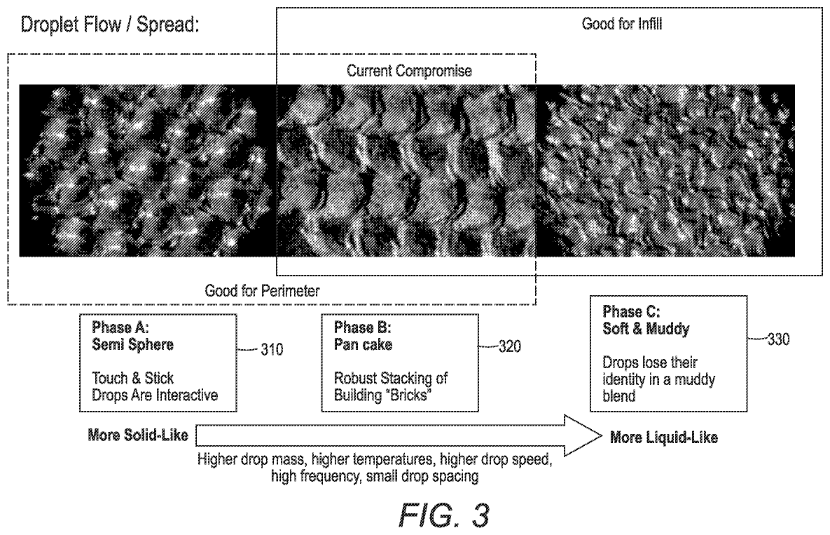

FIG. 3 depicts images of three different phases 310, 320, 330 of solidified drops 122 on the 3D part 124, according to an embodiment. Conventional 3D printers print both the perimeter 210 and the infill 220 using drops 122 in the same (e.g., second) phase 320. As can be seen, these drops 122 solidify and have a “pancake” appearance. However, the controller 150 of the 3D printer 100 described herein may print the perimeter 210 and the infill 220 using drops 122 in different phases. For example, the controller 150 of the 3D printer 100 may print the perimeter 210 using drops 122 in the first phase 310 and the infill 220 using drops 122 in the third phase 330. As can be seen, the drops 122 in the first phase 310 solidify and have a “semi-spherical” appearance, whereas the drops 122 in the third phase 330 solidify and have a “soft and muddy” appearance.

In one embodiment, the parameter(s) used to print the perimeter 210 in the first phase 310 may have a first value, and the same parameter(s) used to print the infill 220 in the third phase 330 may have a second (e.g., different) value. The first value may cause a drop spreading measured in spot size (e.g., the dimension of a solidified drop in the printing layer, usually measured with a diameter D1) in the perimeter 210 to be less than a predetermined threshold DT1, and the second value may cause the drop spreading spot size D2 in the infill 220 to be greater than a predetermined threshold DT2. In some situations, the shape of the drop spreading spot does not resemble a circular area. An effective diameter D′ can be used instead, where the area of the dot spreading is equivalent to a circle with diameter D′. The predetermined spot size thresholds DT1, DT2, in some implementations, may be from about 500 μm to about 1000 μm, with D2 greater than or equal D1. Depending on the actual materials and/or printing conditions, the values of D1 and D2 as well as the predetermined thresholds DT1 and DT2 may have a large range of variations. The system and method described herein may cause D2 in the infill 220 to be significantly greater than D1 in the perimeter 210. For example, D2 in the infill 220 may be more than 10%, more than 15%, or more than 20% greater than D1 in the perimeter 210. Higher ratios of D2/D1 such as 1.5×, 2× or 5× may also be achieved in other embodiments.

In addition to the spot size, the first value can also cause a variation in a height of a layer (measured in Ra) of the perimeter 210 to be greater than a predetermined height threshold, and the second value causes the variation in the height of the layer of the infill 220 to be less than the predetermined height threshold. The variation in height is between the (e.g., average) peaks and the (e.g., average) valleys. The predetermined height threshold Ra may be from about 15 μm to about 25 μm. Depending on the actual materials and/or printing conditions, the predetermined threshold of Ra may have a large range of variations. The system and method described herein may cause the Ra in the perimeter 210 to be significantly higher than the Ra in the infill 220. For example, the Ra in the perimeter 210 may be more than by more than 10%, more than 15%, or more than 20% greater than the Ra in the infill 220.

### Physics of Drop Spreading/Flow/Solidification

The spreading and/or solidification of the drops 122 upon impact on the surface 3D part 124 may be affected by a number of processes and factors. One factor is the impact. More particularly, the initial spreading of the drops 122 may be controlled by the impact. The volume, mass, and/or speed of the drops 122 may be modified to control the impact. For example, higher drop mass and/or higher speed cause more drop spreading.

In this impact dominated spreading, the speed of the drops 122 plays an important role. In one example, a slower drop speed may be used to print the perimeter 210, and a second, higher drop speed may be used to print the infill 220. For example, the perimeter speed may be 2.5 m/s to 3.5 m/s, and the infill speed may be 3.5 m/s to 4.5 m/s. Depending on the actual materials and/or printing conditions, the desired speeds can have a large range of variations. The system and method described herein may cause the drop speed to significantly higher when printing the infill 220. For example, the drop speed may be more than 10%, more than 15%, or more than 20% higher when printing the infill 220 compared to when printing the perimeter 210. In other embodiments, the infill drop speed may be greater than 25%, 50%, or even 100% compared to the perimeter drop speed.

In general, the drops 122 can have more time to spread and/or flow if the cooling and/or solidification of the drop process can be slowed down. In one example, the controller 150 may control the cooling and/or solidification by controlling the “spot-temperature”, namely the local temperature of the build part around the droplet impact spot just before the droplet landing. This spot temperature can be affected/controlled by the print bed temperature, environmental temperature, or more effectively by localized pre-heating, for example high power laser pre-heating. For example, when printing aluminum alloy 4008, the controller 150 may decrease the spot temperature (e.g., from about 470° C. to about 450° C.) when printing the perimeter 210. This may cause the drops 122 to spread less (e.g., phase 310). The controller 150 may also increase the spot temperature (e.g., from about 450° C. to about 500° C.) when printing the infill 220. This may cause the drops 122 to spread more (e.g., phase 330). Depending on the actual materials and printing conditions, the desired spot temperatures can have a huge range of variations. For example, when printing copper, the spot temperature can be much higher than 1000° C. The essence of this invention is to have the spot temperatures significantly higher when printing the infill region, more than 10° C. compared to when printing the perimeters, for example. In other embodiments, spot temperature differences greater than 25° C., 50° C., or even 100° C. may be achieved.

In another example, when printing aluminum alloys, the controller 150 may cause the temperature of the drops 122 to decrease (e.g., to be from about 900° C. to about 825° C.) when printing the perimeter 210. The temperature of the drops 122 refers to the temperature at the time that the drops 122 are ejected from the nozzle 114. This may cause the drops 122 to spread less (e.g., phase 310). The controller 150 may also cause the temperature of the drops 122 to increase (e.g., to be from about 825° C. to about 900° C.) when printing the infill 220. This may cause the drops 122 to spread more (e.g., phase 330). Depending on the actual materials and/or printing conditions, the desired droplet temperatures can have a large range of variations. For example, when printing copper, the temperature can be much higher (e.g., greater than 1000° C.). The system and method described herein may cause the drop temperature to be significantly higher when printing the infill 220 than when printing the perimeter 210. For example, the drop temperature may be more than 20° C., more than 25° C., or more than 30° C. higher when printing the infill 220 than when printing the perimeter 210. In other embodiments, the temperature difference may be greater than 50° C. greater than 100° C., or greater than 200° C.

Drop size may also affect the cooling and/or solidification. In another example, the controller 150 may decrease the size (e.g., volume and/or mass) of the drops 122 when printing the perimeter 210. This may cause the drops 122 to spread less (e.g., phase 310). The provides the benefit of better solidification, and better resolution due to the smaller drop size. The different drop sizes can be achieved through jetting parameters or by using different jetting hardware, or the combination of the two. This may resolve the conflict between higher productivity (e.g., larger drop and higher frequency) and higher resolution (e.g., small drops and better solidification). The controller 150 may also increase the size (e.g., volume and/or mass) of the drops 122 when printing the infill 220. This may cause the drops 122 to spread more (e.g., phase 330). The volume of the drops 122 may be from about 5 uL to about 50 uL when printing the perimeter 210, and from about 50 uL to about 500 uL when printing the infill 220. When printing aluminum alloys, the mass of the drops 122 may be from about 0.015 mg to about 0.15 mg when printing the perimeter 210, and from about 0.15 mg to about 1.5 mg when printing the infill 220. Depending on the actual materials, hardware capabilities, and printing conditions, the desired drop volume and/or mass can have a large range of variations. The system and method described herein may cause the drop size to be significantly higher when printing the infill 220 than when printing the perimeter 210. For example, the drop size may be more than 20% greater, more than 25% greater, or more than 30% greater when printing the infill 220 than when printing the perimeter 210. Higher ratios of drop sizes (e.g., volumes) such as 1.5×, 5×, or 20× may also be achieved.

Drop spacing (reciprocal of the linear density along a toolpath) may also affect the cooling and/or solidification. The position/spacing of each drop 122 affects the subsequent drops 122 because the heat from a previous drop 122 may not be completely dissipated before the subsequent drop 122 lands. Thus, in another example, the controller 150 may increase the spacing between adjacent drops 122 (e.g., to be from about 400 μm to about 500 μm) when printing the perimeter 210. This may cause the drops 122 to spread less (e.g., phase 310). The controller 150 may also decrease the spacing between adjacent drops 122 (e.g., to be from about 600 μm to about 300 μm) when printing the infill 220. This may cause the drops 122 to spread more (e.g., phase 330). Depending on the actual materials, hardware capabilities, and printing conditions, the desired drop density (i.e., reciprocal of drop spacing) can have a large range of variations. The system and method described herein may cause the drop density to be significantly higher when printing the infill 220 than when printing the perimeter 210. For example, the drop density may be more than 15% greater, more than 20% greater, or more than 25% greater when printing the infill 220 than when printing the perimeter 210. Higher ratios of densities such as 1.5×, 3×, or 10× may also be achieved.

Drop frequency may also affect the cooling and/or solidification. This is due the thermal interaction between the drops 122. Higher drop frequency implies less time delay between drops 122, and more heat from the previous drops 122 may affect the spreading of the current drop 122. Thus, in yet another example, the controller 150 may decrease the frequency of the drops 122 when printing the perimeter 210. This may cause the drops 122 to spread less (e.g., phase 310). The controller 150 may also increase the frequency of the drops 122 when printing the infill 220. This may cause the drops 122 to spread more (e.g., phase 330). The frequency at which the drops 122 are ejected from the nozzle 114 may be from about 100 Hz to about 250 Hz or about 150 Hz to about 225 Hz when printing the perimeter 210, and the frequency may be from about 250 Hz to about 450 Hz or about 300 Hz to about 400 Hz when printing the infill 220. Depending on the actual materials, hardware capabilities, and printing conditions, the desired drop frequencies can have a large range of variations, for example, ranging from 10 Hz to 10 kHz. The system and method described herein may cause the drop frequency to be significantly higher when printing the infill 220 than when printing the perimeter 210. For example, the drop frequency may be more than 15% greater, more than 20% greater, or more than 25% greater when printing the infill 220 than when printing the perimeter 210. Higher ratios of frequencies such as 1.5×, 3×, or 10× may also be achieved.

Two or more of the parameters may be modified (e.g., simultaneously) when printing the perimeter 210 and the infill 220. For example, the controller 150 may decrease the size of the drops 122 and increase the frequency of the drops 122 when printing the perimeter 210, and increase the size of the drops 122 and decrease the frequency of the drops 122 when printing the infill 220. The drops 122 that form the perimeter 210 may have a size from about 0.8 g/10 k to about 1.2 g/10 k and a frequency from about 500 Hz to about 1000 Hz. The drops 122 that form the infill 220 may have a size from about 1.3 g/10 k to about 1.7 g/10 k and a frequency from about 300 Hz to about 500 Hz. The high frequency may appear to negate the effect of the smaller drops in terms of enhancing quick solidification, but the net effect of the combination is still beneficial. In addition, higher frequency compensates (or partially compensates) for the loss of productivity caused by smaller drops. There is no loss of throughput for perimeter printing, but part geometrical quality is improved.

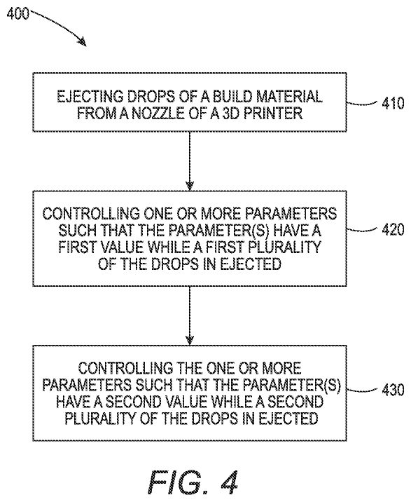

FIG. 4 depicts a flowchart of a method 400 for printing the 3D part 124 with the 3D printer 100, according to an embodiment. More particularly, the 3D printer 100 (e.g., the controller 150) may cause one or more parameters to have different values when printing the perimeter 210 and the infill 220 of the 3D part 124. This causes the drops 122 that form the perimeter 210 to solidify more quickly (e.g., phase 310), thereby maintaining precise drop placement. The geometrical quality of the 3D part 124 part is mostly determined by the perimeter 210. A touch and stick behavior may be generated. This also causes the drops 122 that form the infill 220 to flow and/or spread more quickly (e.g., phase 330) to fill/reduce the potential voids. In addition, slow solidification may give the drop 122 a better chance to bond to the underlying structure through re-melting. The mechanical property of the 3D part 124 is mostly determined by the infill 220. An illustrative order of the method 400 is provided below; however, one or more steps of the method 400 may be performed in a different order, performed simultaneously, repeated, or omitted.

The method 400 may include ejecting the drops 122 of the build material 120 from the nozzle 114 of the 3D printer 100, as at 410. A first plurality of the drops 122 forms the perimeter 210 of the 3D part 124. A second plurality of the drops 122 forms the infill 220 of the 3D part 124.

The method 400 may also include controlling one or more parameters such that the parameter(s) may have a first value while the first plurality of the drops is ejected, as at 420. The first value may cause the first plurality of the drops to cease spreading and/or solidify faster than a predetermined time threshold. As a result, the first value causes a drop spreading measured in spot size (i.e., the dimension of a solidified drop in the printing layer, usually measured with a diameter D1) in the perimeter 210 to be less than a predetermined threshold DT1. Optionally also, as a result, a variation in a height of a layer of the perimeter 210 Ra may be greater than a predetermined height threshold (e.g., phase 310).

The method 400 may also include controlling the one or more parameters such that the parameter(s) may have a second value while the second plurality of the drops is ejected, as at 430. The second value may cause the second plurality of the drops to cease spreading and/or solidify slower than the predetermined time threshold. As a result, the second value causes the drop spreading spot size D2 in the infill 220 to be greater than the predetermined threshold DT2. Optionally, also as a result, the variation in the height of the layer of the infill is less than the predetermined height threshold (e.g., phase 330).

Notwithstanding that the numerical ranges and parameters setting forth the broad scope of the present teachings are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” may include any and all sub-ranges between (and including) the minimum value of zero and the maximum value of 10, that is, any and all sub-ranges having a minimum value of equal to or greater than zero and a maximum value of equal to or less than 10, e.g., 1 to 5.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having.” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A method for printing a 3D part with a 3D printer, the method comprising:
ejecting drops of a build material from a nozzle of the 3D printer, wherein a first plurality of the drops forms a perimeter of the 3D part, and wherein a second plurality of the drops forms an infill of the 3D part;
controlling a parameter such that the parameter has a first value while the first plurality of the drops is ejected; and
controlling the parameter such that the parameter has a second value while the second plurality of the drops is ejected, wherein the first and second values are different.

2. The method of claim 1, wherein the build material comprises a metal.

3. The method of claim 1, wherein the first value causes the first plurality of drops to cease flowing after landing faster than a predetermined time threshold, and wherein the second value causes the first plurality of drops to cease flowing after landing slower than the predetermined time threshold.

4. The method of claim 1, wherein the first value causes the first plurality of drops to cease flowing after reaching a first spot size, wherein the second value causes the second plurality of drops to cease flowing after reaching a second spot size, and wherein the second spot size is at least 15% larger than the first spot size.

5. The method of claim 1, wherein the parameter comprises a frequency at which the drops are ejected, and wherein the first value is less than the second value.

6. The method of claim 1, wherein the parameter comprises a density of the drops, and wherein the second value is at least 20% larger than the first value.

7. The method of claim 1, wherein the parameter comprises a volume of the drops, and wherein the second value is at least 25% larger than the first value.

8. The method of claim 1, wherein the parameter comprises a downward speed of the drops, and wherein the second value is at least 15% larger than the first value.

9. The method of claim 1, wherein the parameter comprises a temperature of the drops when the drops are ejected, and wherein the second value is at least 25° C. higher than the first value.

10. The method of claim 1, wherein the parameter comprises a spot temperature of the drops at landing locations of the drops, at a time just before the drops land, and wherein the second value is at least 10° C. higher than the first value.

11. A method for printing a 3D part with a 3D printer, the method comprising:
ejecting drops of a build material from a nozzle of the 3D printer, wherein a first plurality of the drops forms a perimeter of the 3D part, wherein a second plurality of the drops forms an infill of the 3D part, and wherein the build material comprises a metal;
controlling a parameter such that the parameter has a first value while the first plurality of the drops is ejected, wherein the first value causes the first plurality of the drops to cool to below a predetermined temperature threshold faster than a predetermined time threshold such that a drop spreading induced spot size in the perimeter is less than a predetermined threshold; and
controlling the parameter such that the parameter has a second value while the second plurality of the drops is ejected, and wherein the second value causes the second plurality of the drops to cool to below the predetermined temperature threshold slower than the predetermined time threshold such that a drop spreading induced spot size in the infill is greater than the predetermined threshold,
wherein the parameter comprises:
a frequency at which the drops are ejected,
a density of the drops,
a volume of the drops,
a mass of the drops,
a downward speed of the drops,
a temperature of the drops when the drops are ejected,
a spot temperature of landing spots of the drops prior to the drops landing, or
a combination thereof.

12. The method of claim 11, wherein controlling the parameter such that the parameter has the first value while the first plurality of drops is ejected comprises controlling the mass of each of the first plurality of drops to be from about 0.8 g/10 k to about 1.2 g/10 k.

13. The method of claim 12, wherein controlling the parameter such that the parameter has the first value while the first plurality of drops is ejected comprises controlling the frequency at which each of the first plurality of drops is ejected to be from about 20 Hz to about 1000 Hz.

14. The method of claim 13, wherein controlling the parameter such that the parameter has the second value while the second plurality of drops is ejected comprises controlling the mass of each of the second plurality of drops to be from about 1.3 g/10 k to about 1.7 g/10 k.

15. The method of claim 14, wherein controlling the parameter such that the parameter has the second value while the second plurality of drops is ejected comprises controlling the frequency at which each of the second plurality of drops is ejected to be from about 300 Hz to about 2000 Hz.

16. A 3D printer, comprising:
an ejector comprising a nozzle that is configured to eject drops of a build material, wherein the drops land and solidify to form at least a portion of a 3D part, wherein a first plurality of the drops forms a perimeter of the 3D part, and wherein a second plurality of the drops forms an infill of the 3D part; and
a controller configured to:
control a parameter such that the parameter has a first value while the first plurality of the drops is ejected; and
control the parameter such that the parameter has a second value while the second plurality of the drops is ejected, wherein the first and second values are different.

17. The 3D printer of claim 16, wherein the first and second values cause the first plurality of the drops to appear more semi-spherical than the second plurality of the drops after the first and second pluralities of the drops solidify.

18. The 3D printer of claim 16, wherein the first value causes the first plurality of drops to solidify faster than a predetermined time threshold, and wherein the second value causes the first plurality of drops to solidify slower than the predetermined time threshold.

19. The 3D printer of claim 16, wherein the first value causes a variation in a height of a layer of the perimeter to be greater than a predetermined height threshold, and wherein the second value causes the variation in the height of the layer of the infill to be less than the predetermined height threshold.

20. The 3D printer of claim 16, wherein the parameter comprises a spot size of the drops after landing, and wherein the second value is at least 15% larger than the first value.
